(19) United States
(12) Patent Application Publication
(10) Pub. No.: US 2009/0178180 A1
(43) Pub. Date: Jul. 16, 2009

(54) Garment with Interchangeable Patches

(76) Inventor: Michael Harris, Saugerties, NY (US)

Correspondence Address: BRIAN ROFFE, ESQ, 11 SUNRISE PLAZA, SUITE 303, VALLEY STREAM, NY, 11580-6111, US

(21) Appl. No.: 12/014,210

(22) Filed: Jan. 15, 2008

(51) Int. Cl. A41D 27/08; G09F 21/02

(52) U.S. Cl. 2/244; 40/586

(57) ABSTRACT

Garment with an interchangeable patch system includes at least one panel having one or more openings extending from an inner surface adapted to face the wearer of the garment to an opposed an outer surface, and one or more patches each removably attachable via a front surface to the inner surface of the panel over a respective opening such that an opaque portion of the front surface of the patch is visible via the opening when viewing the outer surface of the panel. To enable the removable attachment of the patches to the panel, the panel and each patch include at least one pair of first and second cooperating fasteners. The first fastener of each pair is arranged on the inner surface of the panel and the second fastener of each pair is arranged on the front surface of the patch.

### FIELD OF THE INVENTION

The present invention relates generally to garments or articles of clothing having interchangeable patches, i.e., a plurality of patches which can independently and individually be attached to the garment to allow the garment to be used with any of the different patches.

The present invention also relates to methods for forming a garment with an interchangeable patch system or modifying a garment to enable its use with interchangeable patches.

### BACKGROUND OF THE INVENTION

One of the major limitations on garments is that they are limiting as to possible variations. That is, each garment is typically manufactured to have a single appearance which cannot be varied once the garment is manufactured. This requires people to purchase multiple garments if they want garments with different appearances, which they do.

However, it appears to be known to manufacture footwear with the ability to place different patches in the footwear and thereby create footwear with the same base and alternating patches. As such, the footwear has different appearances depending on which patch is attached to the base. In this regard, reference is made to U.S. Pat. Nos. 5,800,900 and 6,115,948 (Mitchell), both entitled Decorative Attachments for Articles of Clothing and Footwear. These patents show a shoe with a pocket having a back layer and a front layer having an opening. An interchangeable decorative patch or emblem is arranged in the pocket and includes Velcro® on its front side to engage with Velcro® on the rear side of the front layer.

A drawback of the interchangeable patch system described in the Mitchell patents is that it requires the formation of a pocket to securely retain the patches, i.e., two substrates opposite one another with an opening being formed in the outward facing substrate. Formation of such a pocket typically entails substantial manufacturing work, and thus cost.

It would therefore be desirable to provide a garment or article of clothing with an interchangeable patch system which is easy to manufacture and enables quick and easy interchangeability of the patches to thereby provide the ability to easily change the appearance of a garment.

### OBJECTS AND SUMMARY OF THE INVENTION

It is an object of the present invention to provide new and improved garments incorporating an interchangeable patch system.

It is also an object of the present invention to provide new and improved methods for forming a garment with an interchangeable patch system or modifying a garment to enable its use with interchangeable patches.

In order to achieve one or both of these objects and possibly others, a first embodiment of a garment with an interchangeable patch system in accordance with the invention includes at least one panel having one or more openings extending from an inner surface adapted to face the wearer of the garment to an opposed an outer surface, and one or more patches each removably attachable via a front surface to the inner surface of the panel over a respective opening such that an opaque portion of the front surface of the patch is visible via the opening when viewing the outer surface of the panel. To enable the removable attachment of the patches to the panel, the panel and each patch include at least one pair of first and second cooperating fasteners. The first fastener of each pair is arranged on the inner surface of the panel and the second fastener of each pair is arranged on the front surface of the patch. Possibly fasteners include hook and loop fasteners, e.g., of VELCRO®.

To ensure use of different patches with the same panel of the garment, the second fastener of each pair should be arranged at substantially the same location on all of the patches. The different patches would have different appearances, e.g., have or be made from different substrates which provide a different front surface. Also, a different appearance could be provided by affixing a different logo to multiple portions of the same substrate. It is preferred that the different appearances be provided on that section of the patch which will align with the opening, i.e., on the opaque portion of the patch.

To facilitate attachment of the fasteners to the patches and panel, preferably adhesive is arranged between the fasteners and the panel and patches.

To facilitate secure, yet removable, attachment of the patch to the panel, multiple pairs of first and second fasteners may be provided, for example, on opposite sides of the opening. The size and shape of the fasteners would also be appropriately selected to ensure such secure attachment.

With the foregoing structure, it is not necessary to construct a pocket on the rear surface of the panel to retain the patch. Rather, the panel is retained and supported in connection with the panel solely and exclusively by the fasteners. As a result of the absence of the pocket, when the patch is attached to the panel, both the inner surface of the panel and the rear surface of the patch would contact the same surface of the wearer of the garment or an undergarment worn by the wearer of the garment. If a pocket were used, the pocket would be in contact with the wearer along with the inner surface of the panel.

Moreover, since the portion of the patch which aligns with the opening is opaque, people viewing the garment cannot see the wearer's skin or undergarment, whichever is in contact with the inner surface of the panel.

Another embodiment of garment with an interchangeable patch system in accordance with the invention includes at least one substantially planar panel having at least one opening extending from an inner surface adapted to face the wearer of the garment to an outer surface, and one or more patches having an opaque portion. Each patch is removably attached via a front surface to the inner surface of the panel over a respective opening such that a part of the front surface of the opaque portion of the patch is visible via the opening when viewing the outer surface of the panel. Further, the garment includes a support mechanism for supporting the patch in connection with the panel. The support mechanism consists of one or more pairs of first and second cooperating fasteners, with the first fastener of each pair being arranged on the inner surface of the panel and the second fastener of each pair being arranged on the front surface of the patch. There is no other structure which supports, retains or holds the patches in connection with the panel or otherwise prevents their separation from the panel.

A method for forming a garment with an interchangeable patch system in accordance with the invention provides a garment having at least one panel having at least one opening in an interior portion each extending from an inner surface facing and possibly in contact with a wearer of the garment to an outer surface. The method entails forming a plurality of patches, each patch having a front surface and a rear surface and a different opaque portion, arranging a first fastener of at least one pair of cooperating fasteners on the inner surface of the panel around each opening, and arranging a second fastener of the pair of cooperating fasteners on the front surface of each patch in a position in which the patch will cover a respective opening when the second fastener is engaged with the first fastener on the panel, the second fasteners being arranged in substantially the same position on all of the patches. In use, the wearer individually and removably attaches a desired one of the patches to the panel by engaging the second fastener of each patch to the first fastener of the panel such that part of the front surface of the opaque portion of the attached patch is visible via the opening when viewing the outer surface of the panel. The same variations to the garment described above can be used in this method as well.

### BRIEF DESCRIPTION OF THE DRAWINGS

The invention, together with further objects and advantages, may be best understood by reference to the following description taken in conjunction with the accompanying drawings, wherein like reference materials identify like elements, and wherein:

FIG. 1 is a front view of a garment including an interchangeable patch in accordance with the invention.

FIG. 2 is a front view of an interchangeable patch in accordance with the invention.

FIG. 3 is a side view of the patch shown in FIG. 2.

FIG. 4 is an exploded view of the patch shown in FIG. 3.

FIG. 5 is a side view of the patch shown in FIG. 2.

FIG. 6 is a view of the inner surface of a garment to which the interchangeable patch in accordance with the invention is applied.

FIG. 7 is a side view of the garment shown in FIG. 6.

FIG. 8 is a side view of the garment with a patch attached thereto.

### DETAILED DESCRIPTION OF THE INVENTION

Referring to the accompanying drawings wherein the same reference numerals refer to the same or similar elements, FIG. 1 is a front view of a garment including an interchangeable patch in accordance with the invention. The garment is designated generally as 10 and is a portion of a pair of pants, slacks or jeans. As used herein, the term “garment” means any article of clothing which is worn by a person and including a planar portion of material. Examples of garments include pants, slacks, jeans, shirts, skirts, jackets and coats. The material may be fabric or a synthetic material such as plastic.

Garment 10 includes one or more panels 12 each of which may have one or more openings 14. FIG. 1 shows the front panel of pair of jeans. It is understood that that the jeans also have at least a rear panel which is similar in size and shape to the front panel, and may also have other front, rear and/or side panels. A garment 10 in accordance with the invention can include any number of panels which are sewn, stitched or otherwise attached to one another to form a wearable piece of clothing. Typically, each panel 12 has an inner surface adapted to face the wearer's skin and which may be in contact with the wearer's skin. If not in contact, then the inner surface of the panel 12 could be in contact with the wearer's undergarments. The actual type of garment 10 with which the interchangeable patch system in accordance with the invention is used not material, but it should be stated that the invention would most likely be best applicable to pants, shirts, skirts, dresses and outerwear i.e., articles of clothing which are designed to be worn over a person's legs, torso and/or arms. Footwear is not considered a garment herein.

As described more fully below, a patch 16 is placed over each opening 14. Although only one opening 14 is shown in FIG. 1, the garment 10 can have multiple openings 14 which may be formed inadvertently or accidentally, e.g., in the case of a rip at the knee of a pair of pants which is a common place for such an opening, or intentionally when it is sought to accentuate a particular portion of the garment 10 using a patch 16. Each opening 14 may be in an interior portion of the panel 12, i.e., surrounded by material of the panel and thus entirely bound by an interior edge of the panel 12. Each opening 14 is not covered by any material, i.e., there is no covering, transparent or otherwise, arranged over the opening 14 so that the opening 14 is entirely accessible and visible when viewing the front surface of the panel 12.

Patch 16 includes a substrate 18, two sections 20, 22 of one part of a two-part cooperating fastener and adhesive 24 to securely attach the cooperating fastener sections 20, 22 to a front surface 26 of the substrate 18. Substrate 18 is substantially or entirely opaque, i.e., not transparent. The cooperating fastener sections 20, 22 may be straight, as shown, or curved. The length of each cooperating fastener section 20, 22 may vary from substantially coextensive to the side of the substrate 18 along which it is placed to a minimum necessary to ensure that patch 16 can be securely attached to the panel 12 (in a manner described below). Further, although only two sections 20, 22 are shown, it is conceivable that only a single fastener section may be used in the invention, which single section might extend almost completely or entirely around the edge of the substrate 18. In the same manner, more than two fastener sections may be used, for example, one along each edge of the substrate 18.

The substrate 18 may be a substantially flat or planar piece of material, such as a piece of fabric or a synthetic material such as plastic. The substrate 18 includes an opaque portion which will align with the opening 14, and its remaining portions, which are not visible through the opening 14 when the patch 16 is attached to the panel 12 may either be opaque or transparent, although preferably are also opaque. A design 28 may be formed on the front surface 26 of the substrate 18 as shown in FIG. 1 or the front surface of the substrate 18 may be unadorned and maintain the appearance of the substrate 18. In the latter case, if the substrate 18 is a piece of denim, then the denim would remain as is and would be visible through the opening 14 in the panel 12 when the patch 16 is attached to the panel 12.

Referring now to FIGS. 6 and 7, the inner surface 30 of the panel 12 around the opening 14 is provided with two sections 32, 34 of the other part of the two-part cooperating fastener. For example, if the cooperating fasteners are hook and loop fasteners, sections 20, 22 may be hook fasteners while sections 32, 34 are loop fasteners, and vice versa. The hook and loop fasteners used in the invention may be any commercial type of such fasteners including Velcro®. Moreover, instead of hook and loop fasteners, any type of fastener which has two parts which detachably engage with one another, while providing a secure connection when attached to one another, may be used in the invention.

The sections 32, 34 should generally have the same shape as the sections 20, 22 to enable optimum engagement therebetween. Thus, in the illustrated embodiment, sections 32, 34 are straight and have approximately the same lengths as sections 20, 22. Nevertheless, in view of the possible variations in sections 20, 22 described above, sections 32, 34 may also have the same variations, e.g., with respect to number, shape, size and the like.

Adhesive 36 is used to securely attach the hook and loop fastener sections 32, 34 to the inner surface 30 of the panel 12. Adhesive 24, 36 may be provided in a layer and may be any commercially available adhesive which can be used to securely attach a strip of hook or loop fasteners to a substrate. The adhesive 24, 36 which is used may depend on the composition of the panel 12 and the substrate 18, e.g., when the substrate 18 is fabric, one type of adhesive is used and when the substrate 18 is plastic, a different adhesive is used.

The placement of the fastener sections 32, 34 is important to the practice of the invention since these sections must be positioned to ensure that the patch 16, when the sections 20, 22 thereon engage with sections 32, 34, respectively, covers the opening 14. The patch 16 covers the opening 14 by virtue of the substrate 18 of the patch 16 being positioned alongside substantially the entire opening 14. As such, the only object visible through opening 14 will be the patch 16 and not the skin of the person wearing the garment 10 or an undergarment being worn by the person.

FIG. 8 shows the connection of the panel 12 to the patch 16, with the various fastener sections 20, 32 and adhesive layers 24, 36. FIGS. 3-5, 7 and 8 are slightly exaggerated views, enlarged for the sake of illustration of the invention. In actuality, the fastener sections and adhesive are quite thin so that the rear surface 38 of the patch 16 will be almost contiguous with the inner surface 30 of the panel 12. As such, both the rear surface 38 of the patch and the inner surface 30 of the panel 12 would contact the same surface of the wearer of the garment 10 or the same undergarment worn by the wearer of the garment 10.

In one embodiment, the substrate 18 of the patch 16 is not transparent, but rather is opaque. This is so that the person's skin or undergarments are not visible through the opening 14 and the patch 16.

A method for using an interchangeable patch 16 in accordance with the invention depends on whether the opening 14 in the panel 12 of the garment 10 being covered by the patch 16 is preexisting, e.g., a tear in the garment arising during the normal wear and tear of the garment, or it is desired to accentuate the garment 10 with a particular patch 16.

In the former situation when the garment 10 has a tear which is sought to be covered by the patch 16, the shape of the tear is analyzed to determine the appropriate size and shape of a patch 16 that would sufficiently cover the tear. If desired, the tear may be shaped by cutting the area of the panel 12 of the garment 10 around the tear to provide a more manageable shape, i.e., a shape such as a circle, oval, rectangle and the like. Cutting of the garment 10 may also serve to smooth out the edge of the tear and eliminate loose threads. The end result is an opening 14 which is free of all material and extends between the inner and outer surfaces of the panel 12. This opening is not filled with any material through the thickness of the panel 12 but rather is backed by material, i.e., the patch 16.

In the latter situation when it is desired to accentuate the garment 10, an opening 14 is cut into the panel 12 of the garment 10 at the location at which it is desired to place the patch 16. The opening 14 may have a conventional geometric shape and preferably would be provided with smooth edges without any loose threads.

Once the opening 14 is determined to have an appropriate size and shape, a patch 16 is selected which will cover the opening 14. Selection of a patch 16 may entail selecting a patch 16 which is slightly larger than the opening 14 and has generally the same size. It is pointed out though that the patch 16 is usually larger than the opening 14 and since an excess portion of the patch 16 is not visible when wearing the garment, a larger patch 16 can always be selected. The size of the patch 16 however should be sufficient to completely cover the opening 14, or else the skin of the person wearing the garment 10 or the person undergarments would be visible through opening 14 even when the patch 16 is in place.

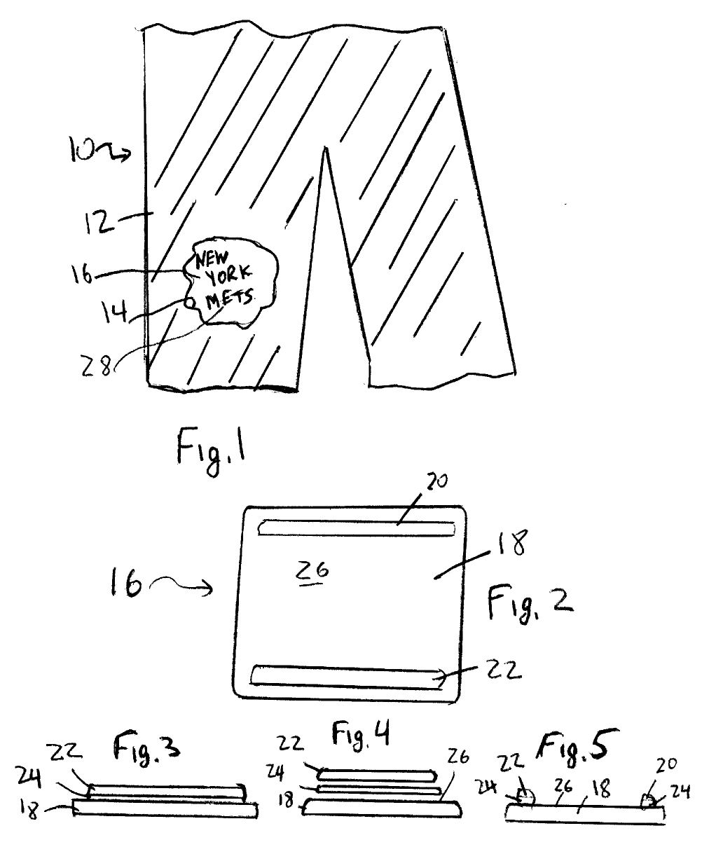

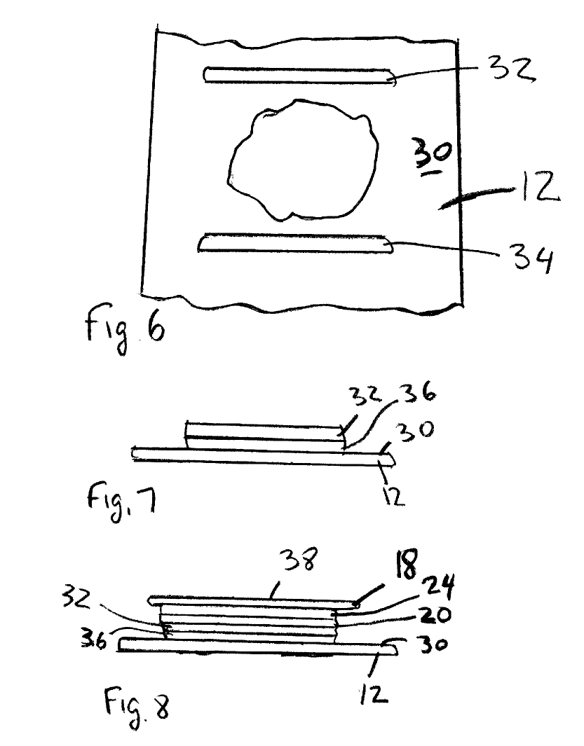

Then, one or more sets or pairs of fasteners are obtained. Each pair of fasteners would include for example, a strip of hook fasteners and a strip of loop fasteners engaged with the hook fasteners with a strip of adhesive arranged on the rear side of each strip of the hook and loop fasteners. Typically, the adhesive would be covered by a releasable backing layer to protect its adhesiveness. The backing layer on one strip of the hook and loop fasteners, of each set, is removed the strip is adhered to the substrate 18. The location at which each strip is adhered to the substrate 18 should be selected to ensure that the substrate 18 will be securely retained around the opening 14. Thus, for example, as shown in FIGS. 2-7, if a pair of strips is used, they would be placed on opposite sides of the opening 14.

At this time, the patch 16 would appear as shown in FIGS. 2-5 with the exception that the sections 32, 34 of the hook and loop fasteners would be engaged with the sections 20, 22 and further adhesive would be present on the rear side of the sections 32, 34 with a backing layer thereon.

Thereafter, the patch 16 is placed against the rear surface of the garment 10 over the opening 14 and adjusted to ensure the desired coverage of the opening 14. The backing layer on the adhesive on the sections 30, 32, is then removed, for example, by gently tilting the patch 16 upward to access the backing layer, and once the backing layer has been removed, the patch 16 is pressed against the garment 10 causing the adhesive on sections 30, 32 to adhere to the garment 10. The patch 16 is thus adhered to the garment 10 via the cooperating sections 20, 22, 32, 34 of hook and loop fasteners.

The patch 16 is interchangeable in that it can be replaced by other patches 16 having substantially the same relative position and orientation of sections 20, 22 of hook and loop fasteners. To this end, a plurality of patches 16 would be formed having the same position and orientation of sections 20, 22 with the main difference being the appearance of the substrate 18, and specifically that opaque portion of the substrate 18 which will be visible through the opening 14 when the patch 16 is attached to the garment 10. As noted above, different appearances of the substrates 18 may be a difference in color, the presence of a particular design, a difference in composition and the like.

To change the patch 16, all that is necessary is to be able to pull the patch 16 currently in place on the garment 10 out of engagement, i.e., by pulling the sections 20, 22 apart from sections 32, 34, and then aligning the sections 20, 22 of a new patch 16 with sections 32, 34 and pressing them firmly together.

The patch 16 can be changed as desired by the wearer. For example, the wearer could change the patch 16 depending on an activity the wearer is engaged in, the time of day, the need to match the patch to other garments, etc.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A garment with an interchangeable patch system, comprising:
at least one substantially planar panel having at least one opening, said panel having an inner surface adapted to face the wearer of the garment and an outer surface, each of said at least one opening extending from said inner surface to said outer surface;
at least one patch having a front surface and a rear surface and an opaque portion, each of said at least one patch being removably attached via said front surface of said patch to said inner surface of said panel over a respective one of said at least one opening such that a part of said front surface of said opaque portion of said patch is visible via said at least one opening when viewing said outer surface of said panel,
said panel and each of said at least one patch including at least one pair of first and second cooperating fasteners, said first fastener of each of said at least one pair being arranged on said inner surface of said panel and said second fastener of each of said at least one pair being arranged on said front surface of said at least one patch.

2. The garment of claim 1, wherein said at least one patch comprises a plurality of patches, said second fastener of each of said at least one pair being arranged at substantially the same location on all said patches such that all of said patches are independently removably attachable to said panel via said first fastener of each of said at least one pair arranged on said panel.

3. The garment of claim 2, wherein each of said patches includes a substrate, said substrate of each of said patches being different than said substrate of the other of said patches.

4. The garment of claim 2, wherein each of said patches includes a different logo on said front surface in a position to be visible through said at least one opening when said patch is attached to said panel.

5. The garment of claim 1, further comprising adhesive arranged between said first fastener and said inner surface of said panel and between said second fastener and said front surface of said at least one patch.

6. The garment of claim 1, wherein said at least one pair of fasteners comprises a plurality of pairs of fasteners.

7. The garment of claim 1, wherein said at least one pair of fasteners comprises first and second pairs of fasteners arranged on opposite sides of said at least one patch.

8. The garment of claim 1, wherein said first fastener is a strip of hook or loop fasteners and said second fastener is a strip of the other of hook and loop fasteners.

9. The garment of claim 1, wherein said panel and said at least one patch are arranged such that when said at least one patch is attached to said panel, both said inner surface of said panel and said rear surface of said at least one patch are adapted to contact the same surface of the wearer of the garment or an undergarment worn by the wearer of the garment.

10. The garment of claim 1, wherein each of said at least one opening is entirely bound by a defined inner edge of said panel.

11. The garment of claim 1, wherein said at least one substantially planar panel comprises a plurality of panels shaped to define a pair of pants.

12. The garment of claim 1, wherein said at least one substantially planar panel comprises a plurality of panels shaped to define a shirt.

13. A method for forming a garment with an interchangeable patch system, the garment having at least one substantially planar panel having at least one opening, the panel having an inner surface facing and possibly in contact with a wearer of the garment and an outer surface, each opening extending from the inner surface to the outer surface, the method comprising:
forming a plurality of patches, each patch having a front surface and a rear surface;
arranging a first fastener of at least one pair of cooperating fasteners on the inner surface of the panel around the at least one opening;
arranging a second fastener of the pair of cooperating fasteners on the front surface of each patch in a position in which the patch will cover the at least one opening when the second fastener is engaged with the first fastener on the panel, the second fasteners being arranged in substantially the same position on all of the patches; and
individually and removably attaching each of the patches to the panel by engaging the second fastener of each patch to the first fastener of the panel such that a portion of the front surface of the attached patch is visible via the at least one opening when viewing the outer surface of the panel.

14. The method of claim 13, wherein each includes a substrate, further comprising forming the substrate of each patch different than the substrate of the other patches.

15. The method of claim 13, further comprising providing each patch with a different logo on the front surface in a position to be visible through the at least one opening when the patch is attached to the panel.

16. The method of claim 13, further comprising arranging adhesive between the first fastener and the inner surface of the panel and between the second fastener and the front surface of each patch.

17. The method of claim 13, wherein the at least one pair of fasteners comprises a plurality of pairs of fasteners, further comprising positioning the pairs of fasteners strategically around the at least one opening to ensure that each patch remains in place on the panel.

18. The method of claim 13, wherein the at least one planar panel comprises a plurality of panels, further comprising shaping the panels to define a pair of pants.

19. The method of claim 13, wherein the at least one planar panel comprises a plurality of panels, further comprising shaping the panels to define a shirt.

20. A garment with an interchangeable patch system, comprising:
at least one substantially planar panel having at least one opening, said panel having an inner surface adapted to face the wearer of the garment and an outer surface, each of said at least one opening extending from said inner surface to said outer surface;
at least one patch having a front surface and a rear surface and an opaque portion, each of said at least one patch being removably attached via said front surface of said patch to said inner surface of said panel over a respective one of said at least one opening such that a part of said front surface of said opaque portion of said patch is visible via said at least one opening when viewing said outer surface of said panel, and
support means for supporting said at least one patch in connection with said panel, said support means consisting of at least one pair of first and second cooperating fasteners, said first fastener of each of said at least one pair being arranged on said inner surface of said panel and said second fastener of each of said at least one pair being arranged on said front surface of said at least one patch.
